(19) United States
(12) Patent Application Publication
(10) Pub. No.: US 2004/0104622 A1
(43) Pub. Date: Jun. 3, 2004

(54) Ever-power 'the straw'

(76) Inventor: Lovelace Cheenecchi Myree, Detroit, MI (US)

Correspondence Address: LOVELACE G. MYREE, 9622 Grand River ave., DETROIT, MI, 48204, US

(21) Appl. No.: 10/291,870

(22) Filed: Nov. 14, 2002

Related U.S. Application Data
(63) Continuation of application No. 09/765,197, now abandoned.

(30) Foreign Application Priority Data
Nov. 14, 2002 (JP) 09/765,197

(51) Int. Cl. H02J 7/00

(52) U.S. Cl. 307/150

(57) ABSTRACT

This is a battery/electric motor circuit with harness energy. This invention has broke man dependency on oil and gasoline, it has curbed our destruction of the ozone, it will give man many days, months and years of free uninterrupted travel, it allows man to make electric power without any overhead cost. Man can travel in any direction thousands of miles and return to the place he started without any cost concerning his vehicle. Man has turned the corner leaving yesterday behind without any strings attached.

### CROSS REFERENCE TO RELATED APPLICATION

In reference to your PTO letter dated Jun. 20, 2001 in regards to patent application Ser. No. 09/765197. Receipt filing date Jan. 18, 2001 and confirmation letter No. 5253 which states; a complete now provisional patent application is needed. All the errors in the above mention patent application have been corrected with this completely new provisional patent application being filed now. Your letter or confirmation No. 5253 is being returned to you at your request.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to the recovering of electric power that the load use up. Here you make one of the first battery electric motor circuit with harness energy. That is completed with it's own charging electric system. To explain and display harness energy and how it works and what you need to make it work.

In the spring of 1991 the people of this country scram to the government to do something about the smog and air pollution. Two years earlier the automobile companies came out with an electric motor for the automobile. They had no electric battery charger for the car. The heat was on to find an electric battery charger for the automobile battery. Today a patent is in motion to meet their needs. This circuit was created to recover power for the battery that's carrying the load. It's called harness energy, with this system the electric power that the motor uses up is retrieved and put back into the battery giving the battery continued life. The electric power retriever is named The Straw. The Straw is a new invention and don't have a name. The Straw will fit between the battery and the alternator with a variable resistor to give more electric power or less electric power.

The life of the electric car is extended 50 years or more as long as the body of the electric car holds up. Here man has solved one of his major problems, no more gasoline, pollution or restricted travel. There's no limit to how far you can travel in a single day without stopping, keep some good tires on your vehicle. The earth is the limit. No more stopping to charge up your automobile battery every few hours. This automatic electric power retrieving circuit will last the life of the vehicle. There is nothing that can go wrong with the circuit.

This is The Straw, it is designed to put the electric power back into the battery that was taken away by the load and to stop man's dependency on oil and to save the ozone. The Straw consist of an electrical wire with an awg size to control the flow of electricity in the retrieving circuit, a variable resistor is spliced into the electrical wire that will retrieve the electrical power with a range 0.5 to 150 ohms. The awg is cut into two pieces, one end of the awg wire is attached to one end of the variable resistor and the other end of the awg wire is attached to the other end of the variable resistor, with the variable resistor splice in place between the two length of awg wire. One end of the awg wire along with the variable resistor is attached to the alternator output circuit outlet and the other end of the awg wire is attached to the positive post of the battery. The retrieving circuit is competed.

This part of the invention relates to the making of a battery, motor generator or alternator circuit to harness energy giving the battery continued life. This invention is made starting with the automobile battery. A battery lug is connector to the positive battery post. A awg wire is cut to length and connected to the positive battery lug, the other end of the awg wire is connected to a standard commercial resistor. An eye connector on a standard commercial resistor, you go to the ground battery post, you put a battery lug on the ground battery post, you use the No. 17 nut on the No. 16 battery lug to tighten it down. Now you cut an awg white ground wire to length, you connect it to the ground wire lug, you go back to the ground battery lug, you cut a awg white ground wire to length, you connect it to the ground battery lug, you take the other end of the awg white ground wire and connect it to the wire connector on the three phase transformer and the lead of the thyrister and connect the three leads together.

You go to the positive power lead of the diode rectifier, you connect it to the positive power lead of the three-phase transformer and the lead of the thyrister, connecting the three lead together. You go to the three output leads of the three phase transformer, you cut three power conductors, two black and one white, you connect the two outside leads to the two black conductors and the white conductor to the center lead of the three phase transformer, you tape up the three power leads, stop there.

Now you lay out a disconnect switch control panel, you install conduit at the top and conduit at the load side (bottom), you go back to the three tape up power conductors, you push them through the conduit at the top of the disconnect switch control panel. You connect the three conductor leads to the switch contacts of the disconnect switch control panel. You go to the load side of the disconnect switch control panel, you cut three conductors to length you connect them to the three contacts on the load side, you tape up the end of the three power conductors coming out of the conduit of the disconnect control panel, at the bottom you push them through the conduit on the top of the motor switch control panel and connect them to the contact on the switch, you got to the load side of the motor switch control panel. You cut three power conductors and connect them to the three contacts on the load side of the motor switch control panel. You go to the other end of the three power conductors and push them through the conduit to the outside and into the conduit of the motor hook panel where they are hook to the motor leads.

Now you go to the alternator or generator, you cut two length of awg black wire, you connect one power conductor to the end of a variable resistor and connect the other power conductor to the other end of the variable resistor, now you connect one end to the positive post of the battery and connect the other power conductor to the out put lead on the alternator or generator. You could say, this unit is ready for work. You go back to the disconnect switch control panel to the fuse block, you insert three knife fuses in three fuse holders, close the disconnect switch, this unit is ready for work.

### BRIEF SUMMARY OF THE INVENTION

This invention is directed to the recovering of electric power with harness energy, this is the first harnessed energy circuit produced or invented. Harness energy keeps the battery supplied with electric power. This battery/electric motor circuit was introduced in 1991 to show man there is light at the end of the tunnel. In those days, people were very concerned about pollution of the environment and we the people cannot afford to stop and give up our way of life. That was thirteen years ago and nothing has been done to meet the challenge, once a man learned how to get himself out of a bad situation. He is not too concerned with it anymore. When harness energy was introduced, man took one look at it and it was love at first sight the love was so great for harness energy that it rolled over the keepers of yesterday and buried the progress blockers paving the way for the invention.

A special thanks is giving to those who took part in removing the obstacles making way for the patent, now the planet can be saved. This is the first battery/electric motor circuit. Produced or invented, before there was no way to replace the electric power that the load used up. This invention is made starting with the automobile battery, a battery lug is connected to the positive battery post. A awg black wire is cut to length and connected to the positive battery lug, the other end to the awg black wire is connected to a standard commercial resistor, another awg black wire is cut to length and connected to the other end of the standard commercial resistor and the end of this awg black wire is connected to the lead of the diode rectifier. You go to the ground battery post and connect a battery lug. To the ground battery post and tighten down, you cut an awg white ground wire to length, you connect it to a ground wire lug.

You take wire lug and connect it to a pipe strap. You go back to the ground battery lug, you cut a awg white ground wire to length, you connect it to the ground battery lug, you take the other end of the awg white ground wire and connect it to the in-put ground lead of the three phase step-up transformer and the thyrister lead and connect the three leads together. Now you go to the other end of the diode rectifier on the positive side of the circuit you take the diode rectifier lead and connect it to the thyrister lead and the three phase step-up transformer positive lead and connect the three leads together. You go to the three out-put leads of the three phase transformer, you cut three awg power leads, two black leads and one white ground lead, you connect the two black power leads to the two outside power leads of the three phase step-up transformer and connect the white ground lead to the center lead of the three phase step-up transformer. You stop here and you, layout a disconnect switch control panel, you take a length of conduit, you install it in the pre-cut hole in the top of the disconnect control panel, you screw a lock washer on the end and put it in the pre-cut hole in the top of the disconnect control panel, you reach inside and screw the second lock washer on the conduit and then the bushing on the inside and a bushing on the top of the conduit. Then you go to the load side of the disconnect control panel. You take a length of conduit, you screw a lock washer on the end of the conduit and you install it in the pre-cut hole in the bottom of the disconnect control panel from the outside, you reach inside the disconnect control panel and screw a lock washer on the end and then screw a bushing on the end and the bushing on the outside end. You go back to the three power lead coming off the transformer out-put leads, you tape up the end and push the three powers lead through the conduit into the disconnect control panel and connect the three power leads to the contacts on the switch in the disconnect control panel. You go to the load side, you cut three power conductors, two black and one white, you connect the two black power conductors to the outside contacts and the white ground conductor to the center contact on the load side of the disconnect control panel. You go to the other end of the three power conductors and tape them up and you stop here, you lay out a motor switch control panel, start and stop button. You take a length of conduit, you screw a lock washer on the end, you install the conduit in the pre-cut hole in the top of the motor control switch panel, you reach inside of the motor control switch panel and screw the second lock washer on the conduit and then the bushing and you screw the second bushing on the top of the conduit, then you go tot the load side of the motor switch control panel, you cut three power conductors, you connect them to the three contact on the load side of the motor switch control panel you tape up the end and you push them through the conduit, here you stop. Take a length of conduit, you screw a lock washer on the end, you install it in a pre-cut hole in the motor hook up panel, you reach inside and screw the second lock washer on the end of the conduit in the hook up motor control panel. Now you screw the bushing on the top and bottom of the hook-up motor control panel. You go back to the conduit at the bottom of the motor switch control panel where the three power conductors are coming from, you take the three power conductors and push them through the conduit into the motor hook-up panel, now you connect or hook them up to a wire nut. Now you got the Straw, the power retrieving circuit. You cut two length of black power conductors, you connect one conductor the end of a variable resistor and the other conductor the other end of the variable resistor, you take the other end of the conductor and connect it to the battery ground post and the other power conductor is connected to the out-put power contact on the alternator or generator. Now this unit is ready for work.

### BRIEF DESCRIPTION OF THE SEVERAL VIEWS OF THE DRAWINGS

FIG. 1A this is a partical south view looking north, the No. 1 battery is here to feed the system with electric power, the No. 16 ground battery lug is here to connect the grounding system to the No. 1 battery the No. 19 white ground conductor is here to carry the grounded point to the No. 1 battery ground, the No. 20 wire lug is here to establish and anchor a ground to the frame of a vehicle, the No. 21 bolt is here to a-line and hold the No. 20 wire lug in place, the No. 21A flat washer is there to keep pressure on the No. 21B nut to keep it tight, the No. 21B nut is there to hold the No. 21 bolt together, You go back to the No. 16 ground batter lug the No. 22A white ground conductor is there to establish a ground for the system.

FIG. 1B is a pattical south view of the No. 1 battery electric circuit showing the No. 3 positive battery lug the No. 100 wire connector is here to be connected the No. 102 connector on the No. 103 variable resistor with a No. 101 screw. No. 101 screw, No. 101A flat washer and a No. 101B nut, the No. 103 variable resistor is here to regulate the power back into the No. 1 battery, the No. 106 wire connector is here to connect the No. 104 connector on the No. 103 variable resistor together with a No. 105 screw, No. 105A flat washer and 105B nut. The No. 107 positive power conductor is here to receive the electric power and deposit it in the No. 3 battery lug. The No. 3 battery lug is here to deposit the electric power back into the No. 1 battery.

FIG. 2 This is a west view, looking east, the No. 22B white ground conductor is there to carry the ground to the system.

FIG. 3. This is a north view looking south, the No. 23 wire connector is here to deliver the ground to the circuit. The No. 25 wire connector is here to receive the ground, the No. 24 screw is here to connect the two together with the No. 24A flat washer and No. 24B nut. The No. 26 input lead of the No. 34 transformer is here to receive and establish a ground in a three-phase AC circuit. The No. 35 output lead of the No.34 three phase transformer is here to establish a second power lead in a three phase AC circuit. The No. 36 wire connector is here to be connected to the No. 38 wire connector with a No. 37 screw. No. 37A washer and a No. 37B nut, the No. 38 wire connector is here to receive the electric AC Power and pass it on, the No. 39 power conductor is here to extend the output lead of the three-phase transformer.

FIG. 4. This is a east view looking west, the No. 50 disconnect switch control panel is here to control the operation of the system. The No. 53 lock washer is there to give the No. 52 conduit a strong connection, the No. 51 plastic bushing is there to protect the awg conductors from the sharp edges on the conduit. The No. 67 lock washer is there to give the No. 68 conduit a strong connection, the No. 69 plastic bushing sis there to protect the awg conductor from the sharp edges on the conduit. The No, 64 awg positive conductor is here to deliver electric power to the No. 70 motor switch control panel. The No. 73 lock washer is here to give the No. 72 conduit a strong connection, the No. 72 conduit is here to give the awg conductor passage to the inside of a control panel. The No. 71 plastic bushing is here to protect the awg conductor from the sharp edges on the No. 72 conduit. Go to the load side the No. 78 lock nut is here to give the No. 79 conduit a strong connection. The No. 79 conduit is here to allow awg conductors passage in and out of a No. 70 motor switch control panel. The No. 80 plastic bushing is here to protect the No. 87 power conductor from the sharp edges on the No. 29 conduit. The No. 87 power conductor is here to deliver electric power to the No. 91 motor hook up panel, the No. 94 lock nut is here to give the No. 95 conduit, a strong connection on the No. 91 motor hook-up panel, the No. 95 conduit is here to give passage to No. 87 power conductors in and out of the No. 95 conduit, the No. 96 plastic bushing is here to protect the No. 87 power conductor from the sharp edges of the No. 95 conduit. The No. 90 5 HP motor is here to turn the No. 97 alternator shaft. The No. 97 alternator is here to make electric power, The No. 98 alternator output circuit panel is here to distribute electric power. The No. 99 positive power conductor (better known as the straw) is here to receive electric power.

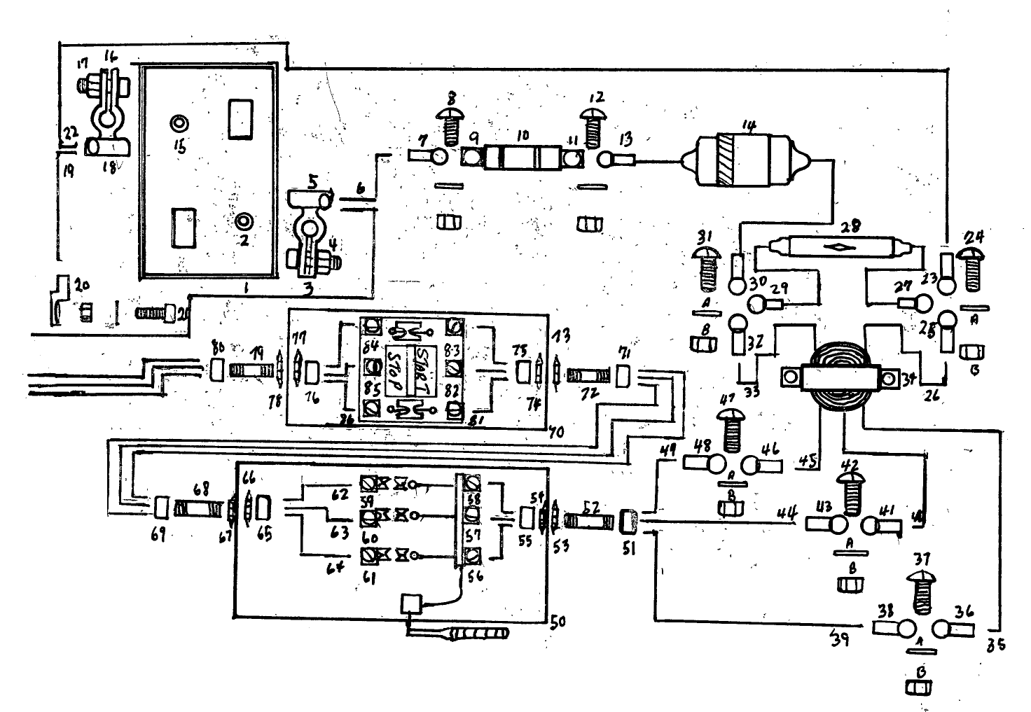

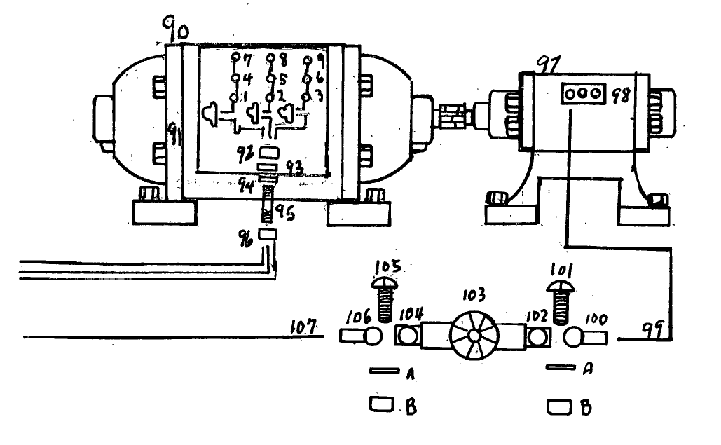

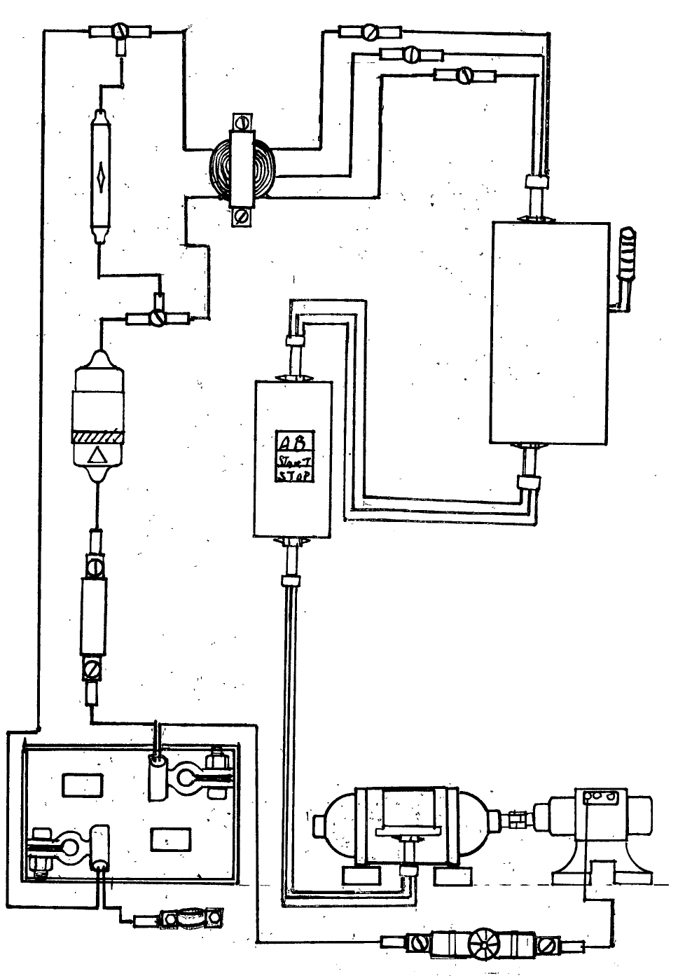

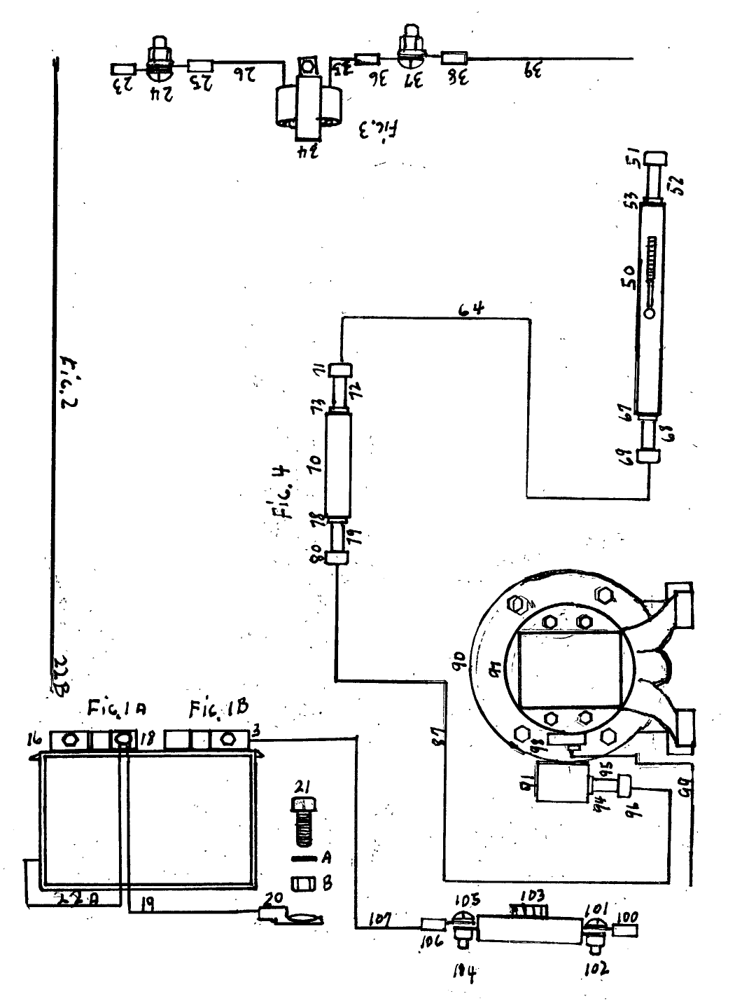

### DETAILED DESCRIPTION OF THE INVENTION

This is one of the first battery/electric motor generator or alternator systems built before there was no way to keep the battery supplied with electric power until now, it's called harness energy.

Here you start with a No. 1 12 volt automobile battery with 950 or more starting amps and pasted plates. Here you place a No. 3 battery lug on the No. 2 positive battery post, you cut a length of power conductor awg No. 6 black (standard) type RH wire 55 amps, you strip a 1/2 in. of insulation off the end, you slip a No. 7 wire connector on the end, you use your wire connector or stak-on pliers to connect the two together, you go to the No. 10 standard commercial resistor, you take the No. 8 screw ¼×20×½ in. and push it through the eye hole of the No. 7 wire connector and through the eye hole of the No. 9 connector on the No. 10 standard commercial resistor. You slip a No. 8A flat washer on the end of the No. 8 screw ¼×20×½ in., you screw the No. 8B nut on by hand you put your box wrench on the No. 8B nut, you put your screwdriver in the slot on the head of the No. 8 screw ¼×20×½ in., you turn your screwdriver clock-wise connecting the two together. You go to the other end of the No. 10 standard commercial resistor, you take the No. 12 ¼×20×½ in. and push it through the eye hole of the No. 13 connector on the No.14 diode rectifier and through the eye hole of the No. 11 connector on the No. 10 standard commercial resistor, you slip a No. 12A flat washer on the end, you screw the No. 12B nut on by hand, you take your box wrench or crescent wrench and put the point in the slot on the head of the No. 12 screw ¼×20×½ in., you turn your screwdriver clock-wise connecting the two together. You go to the No. 15 ground post, you connect the No. 16 ground battery lug to the No. 15 ground battery post, you cut an No.19 white ground conductor awg No. 6 white (standard) type RH wire to length, you strip a ½ in. of insulation off the end, you slop it in the No. 18 wire port of the No. 16 ground battery lug. You go to the other end of the No. 19 white ground conductor awg No. 6 white (standard) type RH wire, you strip a ¾ in. of insulption off the end, you slop a NO.20 wire lug on the end and use your wire crimpers to connect the two together.

Now you drill a ⅜ in. hole in the body or frame of the vehicle where you can get good ground contact for the electric power unit. You take the NO. 21 bolt ⅜in.×¾ in. long, you push it through the eye hole of the No. 20 wire lug and through the eye hole of the frame hole ⅜ in. You take a No. 21A flat washer ⅜ in. and slop it on the No. 21 bolt heads ⅜ in. and screw the No.21B nut on by hand, you take your crescent wrench and put it on the No. 21 bolt head ⅜ in. And screw the No. 21B nut on by hand, you take your crescent wrench and put it on the No.21B bolt head ⅜ in. and put your box wrench on the No. 21B nut ⅜ in. then turn your box wrench clock-wise connecting the two together.

You go back to the No. 16 ground battery lug, you cut a No. 22 white ground conductor awg No. 6 white (standard) type RH wire to length, you strip a ¾ in. of insulation off the end, you slip it into the No. 18 wire port of the NO. 16 ground battery lug, You go to the other end of the No. 22 white ground conductor awg No. 6 white (standard) type RH wire. You strip a ½ in. of insulation off the end you slip a No. 23 wire connector on the end of the NO. 22 ground conductor awg No. 6 white (standard) type RH wire, you use your wire connector or star-on pliers to connect the two together. You go to the No. 26 input ground lead of the NO. 34 three-phase transformer step-up patio 3-1. You strip a ½ in. of insulation off the end, you slip a No. 25 wire connector on the end and use your wire connector or star-on pliers to connect the two together. Now you take the NO. 24 screw ¼×20×½ in. you push it through the eye-hole of the No. 23 wire connector and through the eye hole of the No. 27 lead of the No. 28 thyrister range 0.1 to 1000 amps of blocking force. (the thyrister is there to protect the electronic chip inside the diode rectifier) and through the eye hole of the No. 25 ground input lead of the No. 34 three phase transformer step-up 3-1, you slop a No. 24A flat washer ¼ in. on the end of the No. 24 screw ¼×20×½ in. and screw the No. 24B nut 1/4in. on by hand, you take your screwdriver put the point in the slot on the head of the No. 24 screw ¼×20×½ in. Then put your box wrench on the No 24B nut, you turn your screwdriver clock-wise connecting the three leads together. You go to the No. 33 positive in-put lead of the No. 34 three-phase step-up transformer ratio 2-1, you strip a ½ in. of insulation off the end, you slip a No. 32 wire connector on the end, you use your wire connector or stak-on pliers to connect the two together. Now you take the No. 31 screw ¼×20×½ in., you push it through the eye hole of the No. 30 lead of the No. 14 diode rectifier, power conversion range 0.1 to 1000 amps and through the eye hole of the No. 29 lead of the No. 28 thyrister range 0.1 to 1000 amps of blocking power and through the eye hole of the No. 32 input positive lead of the No. 34 three phase transformer step-up ratio 3-1, you slip a No.31A flat washer ¼ in. on the end of the No. 31 screw ¼×20×½ in. and screw the No. 31B nut on by hand, now take your screwdriver put the point in the slot on the head of the No. 31 screw ¼×20×½ in., then take your box or crescent wrench and put it on th4e No. 31B nut ¼ in. and hold it there, you take your screwdriver and turn it clock-wise connecting the two leads together.

You go to the three out-put leads of the No. 34 three phase step-up transformer ratio 3-1, you go to the No. 35 positive out-put lead of the No. 34 three phase transformer, step-up ratio 3-1, you strip a ½ in. of insulation off the end you slip a No. 36 wire connector on the end to the No. 35 positive out-put lead of the No. 34 three phase step-up transformer ratio 3-1, you use your wire connector or stak-up pliers to connect the two together. You go to the No. 39 positive conductor awg No. 16 black (standard) type RH wire 55 amps, you strip a ½ in. of insulation off the end, you slip a No. 38 wire connector on the end of the No. 39 positive conductor awg No. 6 black (standard) type R wire 55 amps, you use your wire connector or stak-on pliers to connect the two together. You take the No. 37 screw ¼×20×1/2 in. push it through the eye hole of the No.36 wire connector and through the eye hole of the No. 38 wire connector, you slip a No. 37A flat washer ¼ in. on the end of the No. 37 screw ¼×20×½ in. and screw the No. 37B nut on by hand, now take your screwdriver put it in the slot on the head of the No. 37 screw ¼×20×½ in. then take your box wrench or crescent wrench and put it on the No.37B nut ¼ in. and hold it there you take your screwdriver and turn it clock-wise connecting the two leads together. You go to the No. 40 out-put ground lead of the No. 34 three phase step-up transformer ratio 3-1, you strip a ½ in. of insulation off the end, you slip a No. 41 wire connector on the end of the No. 40 out-put ground lead of the No. 34 three phase step-up transformer ratio 3-1, you use your wire connector or stak-on pliers to connect the two leads together, you go to the No.44 ground conductor awg No. 6 white (standard) type R wire, you strip a ½ in. of insulation off the end, you slip a No. 43 wire connector on the end of the No. 44 ground conductor awg a No. 6 white (standard) type RH wire, you use your wire connector or stak-on pliers to connect the two together.

You take the No. 42 screw ¼×20×½ in. you push it through the eye-hole of the No. 41 wire connector and through the eye hole of the No. 43 wire connector. You slip a No. 42A flat washer 1/4 in. on the end to the No.42 screw ¼×20×½ in. and screw the No. 42B nut ¼ in. on by hand, now take your screwdriver put the point in the slot on the head of the No. 42 screw ¼×20×½ in., take your crescent or box wrench, put it on the No. 42B nut ¼ in. and hold it there, you take your screwdriver and turn it clock-wise connecting the two leads together. You go to the No. 45 positive out-put lead of the No.34 three phase step-up transformer ratio 3-1, you strip a ½ in. of insulation off the end you slip a No. 46 wire connector on the end of the No. 45 positive out-put lead of the No. 34 three phase step-up transformer ratio 3 to1, you use your wire connector or stak-on pliers to connect the two leads together. You go to the No. 49 positive power conductor awg No.6 black (standard) type R wire 55 amps, you strip a ½ in of insulation off the end you slip a No. 48 wire connector on the end of the No. 49 positive power conductor awg No. 6 black (standard) type R wire 55 amps, you use your wire connector or stak-on pliers to connect the two leads together. You take the No. 47 screw ¼×20×½ in. you push it through the eye hole of the No. 46 wire connector and through the eye hole of the NO. 48 wire connector, you slip a No. 47A flat washer ¼ in. on the end of the No. 47 screw ¼×20×½ in. you screw the NO. 47B nut ¼ in. on by hand, now take your screwdriver put the point in the slot on the head of the No. 47 screw ¼×20×¼ in., take your crescent or box wrench and put it on the No. 47B nut and take your screwdriver turn it clock-wise connecting the two leads together. You go to the other end of the three power conductors, the NO. 39 positive conductor awg No.6 black (standard) type R wire, 55 amps. The No. 44 ground conductor awg No. 6 white (standard) type R wire and the NO. 49 positive conductor awg black (standard) type R wire 55 amps. You cut the three-power conductor the same length you tape-up the end of the three power conductors you stop here. Now you layout a No. 50 disconnect switch control panel, rated 72 amps, here you take a length of No. 52 conduit 1 mg, you screw a No. 53 lock-washer 1 in. on the end, you put the No. 52 conduit 1 in. in a pre-cut hole 1 in. in the top of the No. 50 disconnect switch control panel, you reach inside and screw the No. 54 second lock-washer on the No. 52 conduit 1 in. and screw a No. 51 plastic bushing on the top of the No. 52 conduit 1 in., now you go the load side of the No. 50 disconnect switch control panel, you take a length of No. 68 conduit ½ in., you screw a No. 67 lock washer ½ in. hole from the outside bottom of the No. 50 disconnect switch control panel, you reach inside and screw the No.66 second lock washer ½ in. on the No. 68 conduit ½ in. Then you screw on the No. 65 plastic bushing ½ in. Then you go to the outside bottom of the No. 50 disconnect switch control panel and screw on the No. 69 plastic bushing ½ in., now you go back to the three power conductors. The No. 39 positive power conductor awg No.6 black (standard) type R wire 55 amps. The No. 44 ground conductor awg No. 12 white (strand) type R wire and the No. 49 positive power conductor awg No. 6 black (strand) type R wire 55 amps. You go back to the end of the taped up power conductors, you push the three power conductors through the NO. 52 conduit 1 in. at the top of the No. 50 disconnect switch control panel to the inside you remove the tape, you cut the three power conductors to the length you want, you take the No. 49 positive power conductor awg No. 6 black (strand) type R wire 55 amps, you strip a ¾ in. of insulation off the end, you take your screwdriver put it in the slot on the No. 58 contact screw head, turn the screwdriver counter clock-wise two turns, you slip the No.49 positive power conductor awg No. 6 black (strand) type R wire behind the No. 58 contact, turn your screwdriver clock-wise connecting the two together.

You take the No. 44 ground conductor awg No. 12 white (strand) type R wire, you strip a ¾ in. of insulation off the end, you take your screwdriver put the point in the slot on the No. 57 contact screw head, turn the screwdriver counter clock-wise two turns to open the No. 57 contact, you slip the No. 44 ground conductor behind the No. 57 contact, you turn your screwdriver clockwise connecting the two together. You take the No. 39 positive power conductor awg No. 6 black (strand) type R wire 55 amps, you strip a ¾ in. of insulation off the end, you take your screwdriver put the point in the slot on the No. 56 contact screw head, you turn the screwdriver counter clockwise two turns to open up the No. 56 contact, you slip the No. 39 positive power conductor awg No. 6 black (strand) type R wire behind the No. 56 contact, you turn your screwdriver click-wise connecting the two together.

You go to the load side of the No. 50 disconnect switch control panel, you cut three power conductors, take the No. 62 positive power conductor awg No. 12 black (strand) type R wire 20 amps, strip ¾ in. of insulation off the end. You take your screwdriver put the point in the slot on the No. 59 contact screw head, you turn the screwdriver counter clock-wise two turns to open up the No. 59 contact, you slip the No. 62 positive power conductor awg No.12 black (strand) type R wire 20 amps behind the No. 59 contact, you turn your screwdriver clock-wise connecting the two together. You take the No. 63 ground conductor awg No. 14 white (strand) type R wire, you strip ¾ in. of insulation off the end, you take your screwdriver put the point in the slot on the No. 60 contact screw head, you turn the screwdriver counter clock-wise tow turns to open up the No. 60 contact, you slip the No. 63 ground conductor awg No. 14 white (strand) type R wire behind the No. 60 contact, you turn your screwdriver clock-wise connecting the two together. You take the No. 64 positive power conductor awg No. 12 black (strand) type R wire 20 amps, you strip a ¾ in. of insulation of f the end, you take your screwdriver put the point in the slot on the No. 61 contact screw head, you turn your screwdriver counter clockwise two turns to open up the No. 612 contact, you slip the No. 64 positive power conductor awg No12 black (strand) type R wire 20 amps behind the No. 61 contact, you turn your screwdriver clockwise connecting the two together. You go to the other end of the three-power conductors the No 62 positive power conductor awg No.12 black (strand) type R wire 20 amps, the No. 63 ground conductor awg No. 14 white (strand) type R wire and the No. 64 positive power conductor awg No. 12 black (strand) type R wire 20 amps. You take the three taped up ends and push them through the No. 68 conduit ½ in. to the outside of the No. 50 disconnect switch control panel. You stop here, you layout a No. 70 motor switch control panel, you take a length of No. 72 conduit ½ in.×12 in., you screw a No. 73 lock washer 1/2 in. on the end, you put the end in a pre-cut hole ½ in. in the top of the No. 70 motor switch control panel you reach inside and screw on the No. 74 lock washer 1/2 in. and then you screw on the No. 75 plastic bushing, you go to the top of the No. 72 conduit 1/2 in. and screw on the No. 71 plastic bushing. Now you go to the load side (bottom) you take a length of No. 79 conduit ½ in. and screw on a No. 78 lock washer ½ in. and put the No. 79 conduit ½ in. in a pre-cut hole in the bottom of the No. 70 motor switch control panel from the outside you reach inside and screw on the second No. 79 lock washer ½ in. and then the No. 76 plastic bushing 1/2 in. you go back to the outside and screw on the No. 80 plastic bushing ½ in. on the end of the No. 79 conduit ½ in., you back to the No. 68 conduit ½ in. on the No. 50 disconnect switch control panel, you take the three taped up leads and push them through the No. 72 conduit ½ in. into the No. 70 motor switch control panel, start and stop button switch. You take the No. 62 positive power conductor awg No. 12 black (strand) type R wire 20 amps, you strip a ¾ in. of insulation off the end, you take your screwdriver put the point in the slot on the No. 873 contact screw head, you turn your screwdriver counter clockwise two turns opening up the No. 83 contact, you skip the No. 62 positive power conductor behind the No. 83 contact you turn your screwdriver clockwise connecting the two together. You take the No. 63 ground conductor awg No. 14 white (strand) type R wire, you strip a ¾ in. of insulation off the end, you take your screwdriver put the point in the slot on the No. 82 contact screw head, you turn your screwdriver counter clockwise two turns opening up the No. 82 contact, you slip the No. 63 ground conductor behind the No. 82 contact you turn your screwdriver clock wise connecting the two together. You take the No. 64 positive power conductor awg black (strand) type R wire 20 amps, you strip a ¾ in. of insulation off the end, you take your screwdriver put the point in the slot on the No. 81 contact screw head, you turn your screwdriver counter clockwise two turns opening up the No. 81 contact you slip the No. 64 positive power conductor behind the No. 81 contact, you turn your screwdriver clockwise connecting the two together.

Now you go to the load side of the No. 70 motor switch control panel, you cut three power conductors, you take the No. 89 positive power conductor awg No. 14 black (strand) type R wire 15 amps, you strip a ¾ in. of insulation off the end, you take your screwdriver, put the point in the slot on the No. 84 contact screw head you turn the screwdriver counter clockwise two turns to open up the No. 84 contact, you slip the No. 84 positive power conductor awg No.14 black (strand) type R wire 15 amps, behind the No. 84 contact you turn your screwdriver clockwise connecting the two together. You take the No. 88 ground conductor awg No. 14 white (strand) type R wire, you strip a ¾ in. of insulation off the end you take your screwdriver put the point in the slot on the No. 85 contact screw head you turn the screwdriver counter clockwise two turns to open up the No. 85 contact, you skip the No. 88 ground conductor awg No. 14 white (strand) type R wire, behind the No. 85 contact, you turn your screwdriver clockwise connecting the two together. You take the No. 87 positive power conductor awg No. 14 black (strand) type R wire 15 amps, you strip a ¾ in. of insulation off the end you take your screwdriver put the point into the slot on the No. 86 contact screw head you turn your screwdriver counter clockwise two turns to open up the No. 86 contact you slip the No. 87 positive power conductor behind the No. 86 contact you turn your screwdriver clockwise connecting the two together.

You go to the other end of the three power conductors, you tape up the end you push the taped up ends through the No. 79 conduit ½ in. to the outside of the No. 70 motor switch control panel, you stop here! You lay-out a No. 90 5 HP motor induction type 220 volts 3 phase and a No.97 alternator or generator 110-220 amps 3 phase, you go to the No. 91 motor hook up panel, you take a length of No. 95 conduit ½ in. you screw a No. 94 lock washer ½ in. on the end you put the No. 95 conduit ½ in. in a pre-cut hole at the bottom of the No. 91 motor hook-up panel, you reach inside and screw on No. 93 second lock washer ½ in.and then screw on the No. 92 plastic bushing ½ in. you go to the bottom end of the No. 95 conduit ½ in. and screw on the No. 96 plastic bushing ½ in., now you go back to the three taped up conductors coming out of the No. 79 conduit ½ in. at the bottom of the No. 70 motor switch control panel and you push them into the No. 95 conduit ½ in. going into the bottom of the No. 91 motor hook-up panel to the inside, you take the No. 89 positive power conductor awg No. 14 black (strand) type R wire 15 amps, you strip a ¾ in. of insulation off the end, now you go to the No. 1 motor lead you strip a ¾ in. of insulation off the end you put the two wires together end to end, you make sure the ends are even then you push the two wires into the No. 1A wire nut med. turn the No. 1A wire nut clockwise tightening the two wires into a strong bond connecting them together.

You take the No. 88 ground conductor awg No. 14 white (strand) type R wire you stip a ¾ in. of insulation off the end, now you go to the No. 1A motor lead, you strip a ¾ in. of insulation off the end you put the two wires together, end on end, make sure the ends are even, then you push the two wires into the No. 2A wire nut med. Turn the No. 2A wire nut clockwise tightening the two

1. What I claim as my invention is: I claim the Straw the retrieving power circuit is the first of it's kind.

2. What I claim as my invention is: I claim the battery/electric motor circuit with harness energy.
